(19) United States
(12) Patent Application Publication
(10) Pub. No.: US 2017/0046507 A1
(43) Pub. Date: Feb. 16, 2017

(54) CONTINUOUS FACIAL RECOGNITION FOR ADAPTIVE DATA RESTRICTION

(71) Applicant: International Business Machines Corporation, Armonk, NY (US)

(72) Inventors: Adam G. Archer, Toronto (CA); Herman S. Badwal, Markham (CA); Robin Y. Bobbitt, Raleigh, NC (US); Prachi S. Khadke, Arlington, MA (US); Christopher M. Lee-Shanok, Toronto (CA); Robert Retchless, Toronto (CA); Fariz Saracevic, Sterling, VA (US); Christopher N. Taylor, Newmarket (CA)

(21) Appl. No.: 14/822,139

(22) Filed: Aug. 10, 2015

(51) Int. Cl. G06F 21/32; G06F 21/62; G06K 9/00

(52) U.S. Cl. CPC G06F 21/32; G06K 9/00255; G06K 9/00288; G06K 9/00295; G06F 21/6218

(57) ABSTRACT

In an approach to user authentication by facial recognition, a computing device repeatedly detects the faces of users within the field of view of an input device. The computing device determines the presence or absence of the registered user within the field of view of the input device. The computing device determines the presence or absence of unregistered users within the field of view of the input device. Determining that only the registered user is present, the computing device presents data in an unrestricted manner. Determining that an unregistered user(s) is present, the computing device presents data in a restricted manner.

### TECHNICAL FIELD OF THE INVENTION

The present invention relates generally to the field of computing device security, and more particularly to user authentication by facial recognition.

### BACKGROUND OF THE INVENTION

Computing devices commonly store both public data and private data. Depending on the sensitivity of stored private data, its inadvertent disclosure to individuals other than the owner of the device can have negative consequences ranging from a socially awkward situation to serious and costly legal ramifications. Because it is common practice for a device owner to share his or her device informally with other individuals, or to work with private data on his or her device in a public setting, a need arises for tools that quickly, subtly, and adaptively protect against inadvertent disclosure of private data in unpredictable situations.

### SUMMARY

According to one embodiment of the present invention, a method for restricting access to data using facial recognition is provided. A computing device repeatedly detects facial representations visible within a field of view of one or more input devices. The computing device determines the presence of a registered user based on matching at least one of the detected facial representations with a registered facial representation, or the absence of a registered user based on not matching any of the detected facial representations with the registered facial representation, wherein the registered facial representation is associated with the registered user. The computing device determines the presence of one or more unregistered users based on not matching any of the detected facial representations with the registered facial representation, or the absence of one or more unregistered users based on matching all of the detected facial representations with the registered facial representation. The computing device, responsive to determining the presence of the registered user and the absence of the one or more unregistered users, presents data in a first, unrestricted manner. The computing device, responsive to determining the presence of the one or more unregistered users, presents data in a second, restricted manner.

According to another embodiment of the present invention, a computer program product is provided. The computer program product can include one or more computer readable storage media and program instructions stored on the one or more computer readable storage media, the program instructions comprising: program instructions to detect repeatedly facial representations visible within a field of view of one or more input devices; program instructions to determine the presence of a registered user based on matching at least one of the detected facial representations with a registered facial representation, or the absence of a registered user based on not matching any of the detected facial representations with the registered facial representation, wherein the registered facial representation is associated with the registered user; program instructions to determine the presence of one or more unregistered users based on not matching any of the detected facial representations with the registered facial representation, or the absence of one or more unregistered users based on matching all of the detected facial representations with the registered facial representation; program instructions to present, responsive to determining the presence of the registered user and the absence of the one or more unregistered users, data in a first, unrestricted manner; and program instructions to present, responsive to determining the presence of the one or more unregistered users, data in a second, restricted manner.

According to another embodiment of the present invention, an adaptive restriction system is provided. The adaptive restriction system can include one or more user interfaces; one or more input devices; one or more processors; one or more computer readable storage media; and program instructions stored on the one or more computer readable storage media for execution by at least one of the one or more processors, the program instructions comprising: program instructions to detect repeatedly facial representations visible within a field of view of one or more input devices; program instructions to determine the presence of a registered user based on matching at least one of the detected facial representations with a registered facial representation, or the absence of a registered user based on not matching any of the detected facial representations with the registered facial representation, wherein the registered facial representation is associated with the registered user; program instructions to determine the presence of one or more unregistered users based on not matching any of the detected facial representations with the registered facial representation, or the absence of one or more unregistered users based on matching all of the detected facial representations with the registered facial representation; program instructions to present, responsive to determining the presence of the registered user and the absence of the one or more unregistered users, data in a first, unrestricted manner; and program instructions to present, responsive to determining the presence of the one or more unregistered users, data in a second, restricted manner.

### BRIEF DESCRIPTION OF THE DRAWINGS

FIG. 1 is a functional block diagram of an exemplary computing environment, in accordance with an embodiment of the present invention;

FIG. 2 is a flowchart depicting operational steps of a continuous authentication method, in accordance with an embodiment of the present invention;

FIG. 3A-C are flowcharts depicting operational steps of an adaptive restriction method for responding to detection of a registered user only, an unregistered user only, and a registered user and an unregistered user together, respectively, in accordance with an embodiment of the present invention;

FIG. 4A-F are diagrams illustrating adaptation of a user interface responsive to detecting a registered user and an unregistered user together (FIGS. 4A-D), an unregistered user only (FIG. 4E), and a registered user only (FIG. 4F), in accordance with an embodiment of the present invention; and

FIG. 5 is a block diagram of components of the computing device in FIG. 1 executing a continuous authentication program, in accordance with an embodiment of the present invention.

### DETAILED DESCRIPTION

Embodiments described herein respond to the challenges of preventing inadvertent disclosure of private data when using a computing device in the presence of others. Existing approaches to restricting access to data stored on a device do not always rise to the level of practicality or subtlety that would prevent embarrassment or other harm to the owner of the device in an unpredictable situation (e.g., in the case of casual sharing or use in a public place). Approaches disclosed in the prior art can inconvenience users or compromise some measure of privacy by, for example:
(1) requiring that a registered user log out in order to restrict third party access,
(2) alerting third parties to sensitive data stored on the device by overtly changing access levels in a their presence (e.g., requiring that the third party register or log into a separate account),
(3) completely locking the device when the device owner is not detected, or
(4) remaining fully accessible to third parties when the device owner forgets to adjust security settings before sharing the device or leaving the device unattended.
   The embodiments disclosed herein can avoid such inconvenience or inadvertent disclosure in dynamic, unpredictable settings, and can provide enhanced privacy.

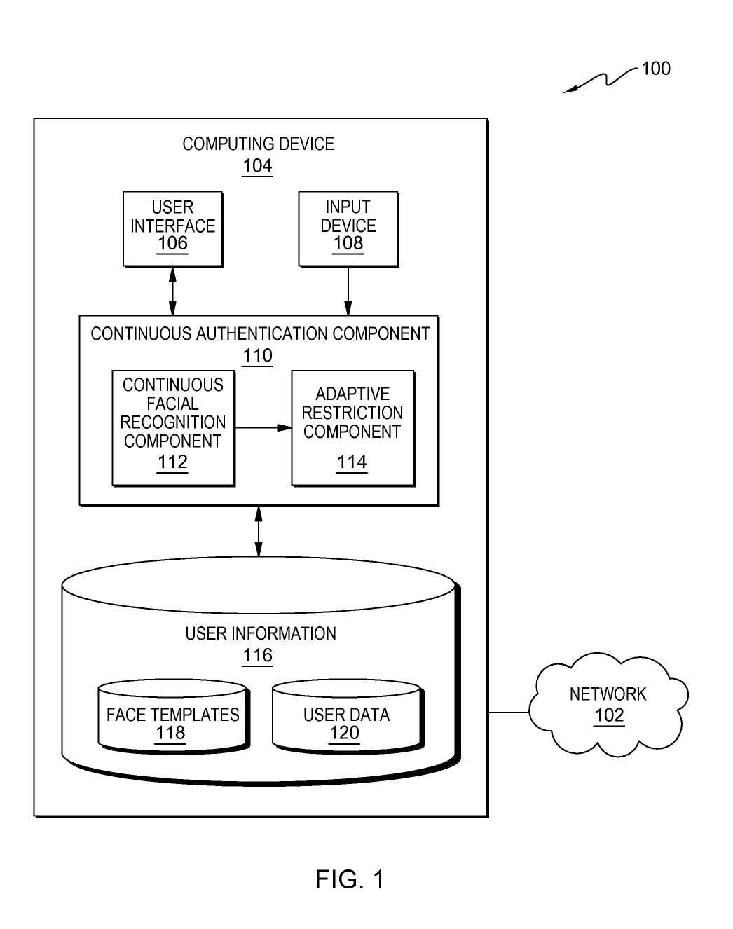

FIG. 1 shows a block diagram of a computing environment 100, in accordance with one embodiment of the present invention. FIG. 1 is provided for the purposes of illustration and does not imply any limitations with regard to the environments in which different embodiments can be implemented. Many modifications to the depicted environment can be made by those skilled in the art without departing from the scope of the invention as recited in the claims.

Computing environment 100 includes computing device 104, which can be interconnected with other devices (not shown) over network 102. Network 102 can be, for example, a telecommunications network, a local area network (LAN), a wide area network (WAN), such as the Internet, or a combination of these, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between computing device 104 and other computing devices (not shown) within computing environment 100.

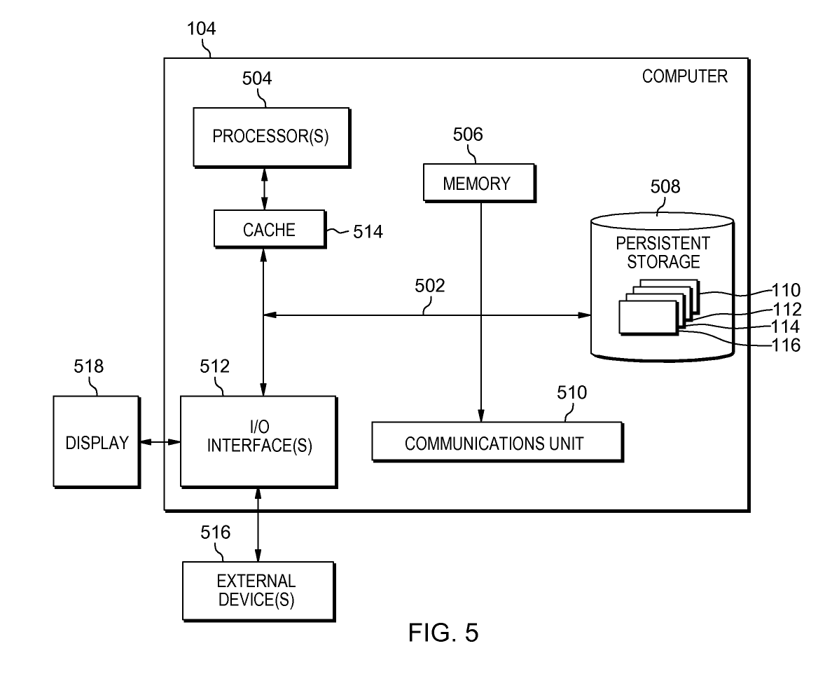

Computing device 104 can be a mobile device, such as but not limited to a smartphone or tablet computer, or any programmable electronic device capable of executing machine-readable instructions. Computing device 104 includes user interface 106, input device 108, continuous authentication component 110, and user information 116. Computing device 104 can include internal and external hardware components, as depicted and described in further detail with respect to FIG. 5.

User interface 106 provides an interface between a user of computing device 104 and computing device 104. User interface 106 can be, but is not limited to being, a graphical user interface (GUI) or a web user interface (WUI) and can display text, documents, web browser windows, user options, application interfaces, and instructions for operation, and can include the information (such as graphic, text, and sound) presented to a user and the control sequences the user employs to control continuous authentication component 110.

Input device 108 can be a visual input device, such as but not limited to a front-facing video camera, which captures and transmits images of the face(s) within its field of view to continuous authentication component 110 with a predetermined frequency.

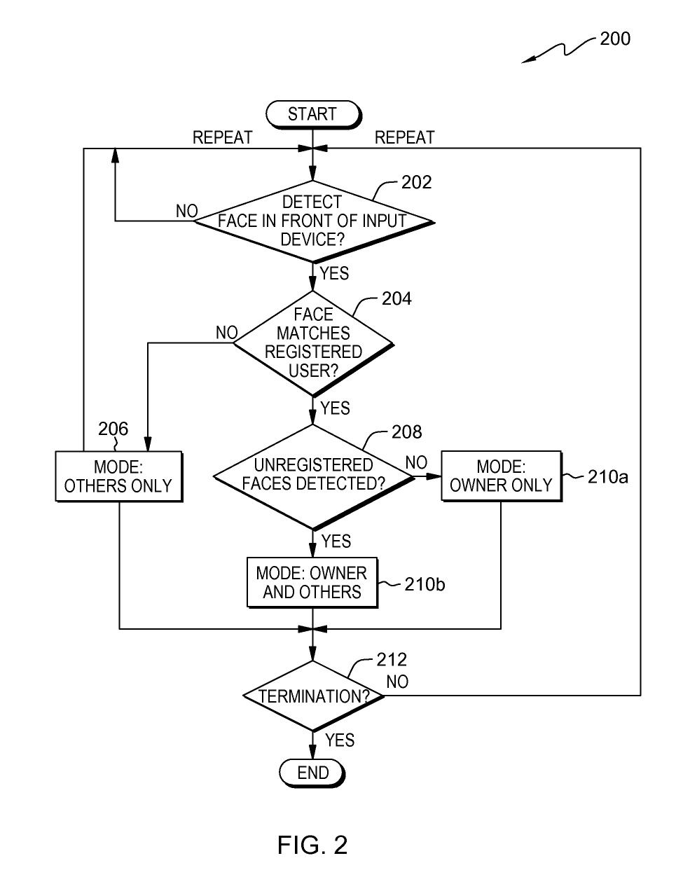

Continuous authentication component 110 includes continuous facial recognition component 112 and adaptive restriction component 114. FIG. 2 is a flowchart 200 depicting an example of operational steps performed by continuous facial recognition component 112 in accordance with an embodiment of the present invention. In step 202, continuous facial recognition component 112 searches the field of view of input device 108 for faces. Search algorithms capable of detecting faces for the purposes of real-time facial recognition are well known in the prior art. If continuous facial recognition component 112 does not detect a face in the field of view of input device 108, continuous facial recognition component 112 continues to search with a predefined frequency until continuous facial recognition component 112 detects a face.

In step 204, continuous facial recognition component 112 compares the face images transmitted by input device 108 to images of registered users stored as face templates 118 in user information 116, in order to detect the presence of a registered user. A registered user can be, but is not limited to being, a user whose face template 118 is saved in user information 116, e.g., when continuous authentication component 110 is downloaded onto, installed on, or run on computing device 104 for the first time. If face images transmitted by input device 108 to continuous facial recognition component 112 in step 202 do not match the representation of a registered user stored in face templates 118 in step 204, then continuous facial recognition component 112 instructs adaptive restriction component 114 to activate “Others Only” mode in step 206.

If face images transmitted by input device 108 to continuous facial recognition component 112 match the representation of a registered user stored in face templates 118 in step 204, continuous facial recognition component 112 searches for faces of unregistered users within the field of view of input device 108 in step 208. If continuous facial recognition component 112 does not detect the presence of unregistered user(s) in step 208, continuous facial component 112 instructs adaptive restriction component 114 to activate “Owner Only” mode in step 210a. If continuous facial recognition component 112 detects the presence of unregistered user(s) in step 208, continuous facial recognition component 112 instructs adaptive restriction component 114 to activate “Owner and Others” mode in step 210b.

Continuous facial recognition component 112 repeats steps 202-210 at a predefined frequency until the user terminates the continuous authentication in step 212 by, for example, turning off computing device 104.

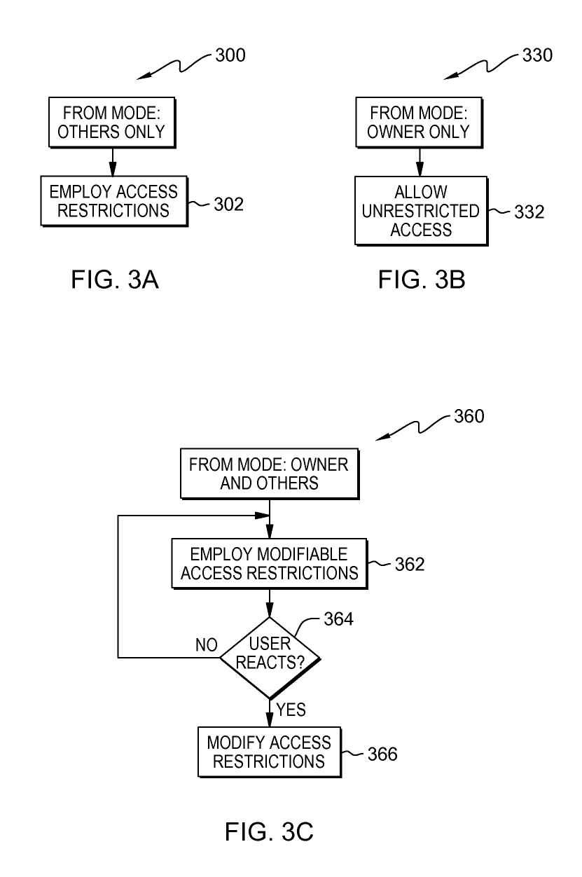

FIG. 3A-C show examples of steps that adaptive restriction component 114 can take responsive to receiving an instruction from continuous facial recognition component 112 to activate “Others Only” mode, “Owner Only” mode, or “Owner and Others” mode, in accordance with an embodiment of the present invention. For example, as shown in FIG. 3A, responsive to receiving an instruction from continuous facial recognition component 112 to activate “Others Only” mode, adaptive restriction component 114 employs access restrictions in step 302. Access restrictions are defined as changes to user interface 106 that limit or preclude the ability of an unregistered user(s) to access private user data 120 that would ordinarily be accessible on the device. User data 120 is defined as including, but not being limited to, at least one of text, files, folders, graphics, icons, application data, and applications stored or run on computing device 104. A registered user using computing device 104 in “Owner Only” mode, as described herein with reference to FIG. 3B, can define which user data 120 is private by marking it as such (e.g., by marking a photo as private after capturing or uploading it, or by marking an application as private after downloading it). Access restrictions in “Others Only” mode can include, but are not limited to, the following changes to user interface 106: Applications that provide access to user data 120 marked private can become invisible or inaccessible, applications that provide access to private and public user data 120 can behave as though they hold only public user data 120, details pertaining to contacts marked private can be hidden, notifications pertaining to private user data 120 can be suppressed.

As shown in FIG. 3B, responsive to receiving an instruction from continuous facial recognition component 112 to activate “Owner Only” mode, adaptive restriction component 114 allows unrestricted access in step 332. Unrestricted access is defined as the absence of access restrictions such as those described with reference to FIG. 3A and FIG. 3C.

As shown in FIG. 3C, responsive to receiving an instruction from continuous facial recognition component 112 to activate “Owner and Others” mode, adaptive restriction component 114 employs modifiable access restrictions in step 362. Modifiable access restrictions can include, but are not limited to including, the following changes to user interface 106: Password entry boxes can hide the characters entered, notifications pertaining to private user data 120 can appear as nondescript indicators, and private user data 120 inadvertently displayed (e.g., by the user running an application) can be hidden. Responsive to detecting a predefined user interaction with user interface 106 in step 364, adaptive restriction component 114 can modify the modifiable access restrictions in step 366 to reveal the corresponding private data previously hidden in step 362. For example, responsive to a finger-tap on the nondescript indicator in the previous example, adaptive restriction component 114 can reveal the full contents of the notification in step 366.

It should be noted that the examples described with reference to FIG. 3A-C are provided for the purposes of illustration and do not imply any limitations with regard to possible embodiments and their implementation. For example, many other access restrictions and modifiable access restrictions can be employed without departing from the scope of the present invention as recited in the claims.

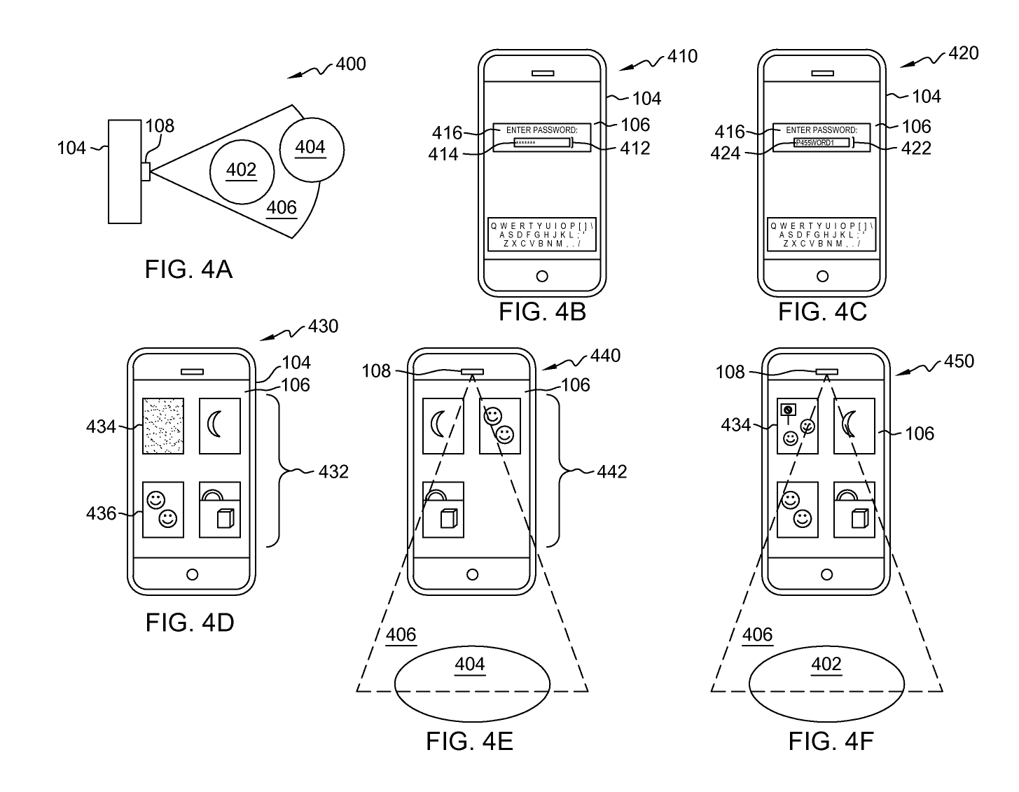

FIG. 4A-F are diagrams illustrating the adaptation of user interface 106 responsive to detection of a registered user and an unregistered user together (FIGS. 4A-D), an unregistered user only (FIG. 4E), and a registered user only (FIG. 4F), in accordance with an embodiment of the present invention.

FIG. 4A shows an example 400 of a registered user 402 and an unregistered user 404 within the field of view 406 of input device 108 of computing device 104.

FIG. 4B shows an example 410 of a modifiable access restriction 412 employed to alter user interface 106 of computing device 104 in “Owner and Others” mode, in accordance with the scenario depicted in example 400. In example 410, modifiable access restriction 412 obscures the characters 414 entered into computing device 104 in response to a password prompt 416.

FIG. 4C shows an example 420 of the modified version 422 of modifiable access restriction 412 from example 410. Responsive to a predefined user gesture (not shown) such as a finger-tap on user interface 106, modified version 422 reveals the characters 424 (characters 414 in example 410) entered in response to password prompt 416.

FIG. 4D shows another example 430 of a modifiable access restriction 432 employed to alter user interface 106 of computing device 104 in “Owner and Others” mode, in accordance with the scenario depicted in example 400. In example 430, modifiable access restriction 432 obscures photo 434, previously marked as sensitive by registered user 402. In contrast, in example 430, photo 436 has not been marked sensitive and is therefore unobscured. In other examples, modifiable access restriction 432 could analogously obscure data including, but not limited to, messages, documents, emails, bookmarks, and entries in a web browser history.

FIG. 4E shows an example 440 of an unmodifiable access restriction 442 employed to alter user interface 106 of computing device 104 in “Others Only” mode, in accordance with a change to the scenario depicted in example 400 in which only unregistered user 404 is present in the field of view 406 of input device 108. In example 440, unmodifiable access restriction 442 hides photo 434 (not shown) from user interface 106.

FIG. 4F shows an example 450 of user interface 106 of example 430 and example 440, now in “Owner Only” mode in the presence of registered user 402 alone in the field of view 406 of input device 108. In example 440, no access restrictions are employed, and photo 434 is visible and unobscured.

FIG. 5 is a block diagram of components of a computing device executing operations for continuous facial recognition enabled adaptive data restriction, in accordance with an embodiment of the present invention. For example, FIG. 5 is a block diagram of computing device 104 within computing environment 100 executing operations of continuous authentication component 110, continuous facial recognition component 112, and adaptive restriction component 114.

It should be appreciated that FIG. 5 provides only an illustration of one implementation and does not imply any limitations with regard to the environments in which different embodiments can be implemented.

Computing device 104 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 can include any suitable volatile or non-volatile computer-readable storage media. Cache 514 is a fast memory that enhances the performance of processor(s) 504 by holding recently accessed data, and data near recently accessed data, from memory 506.

Program instructions and data used to practice embodiments of the present invention, e.g., user interface 106, continuous authentication component 110, continuous facial recognition component 112, adaptive restriction component 114, and user information 116, are stored in persistent storage 508 for execution and/or access by one or more of the respective computer processors 504 via one or more memories of memory 506. In this embodiment, persistent storage 508 includes a magnetic hard disk drive. Alternatively, in addition to a magnetic hard disk drive, persistent storage 508 can include a solid state hard drive, a semiconductor storage device, read-only memory (ROM), erasable programmable ready-only memory (EPROM), flash memory, or any other computer-readable storage media that is capable of storing program instructions or digital information.

The media used in persistent storage 508 may be removable. For example, a removable hard disk drive may be used for persistent storage. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Continuous authentication component 110, continuous facial recognition component 112, and adaptive restriction component 114 can be downloaded to persistent storage 508 through communications unit 510.

I/O interface(s) 512 allows for input and output of data with other devices that may be connected to computing device 104. For example, I/O interface 512 can provide a connection to external devices 516 such as a keyboard and/or some other suitable input device. External devices 516 can also include portable computer-readable storage media such as, for example, thumb drives, portable optical or magnetic disks, and memory cards. Software and data used to practice embodiments of the present invention (e.g., continuous authentication component 110, continuous facial recognition component 112, and adaptive restriction component 114) can be stored on such portable computer-readable storage media and can be loaded onto persistent storage 508 via I/O interface(s) 512. I/O interface(s) 512 can also connect to a display 518.

Display 518 provides a mechanism to display data to a user and can be, for example, a touchscreen display.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for restricting access to data based on facial recognition, the method comprising:
detecting repeatedly, by one or more processors, facial representations visible within a field of view of one or more input devices;
determining, by one or more processors, the presence of a registered user based on matching at least one of the detected facial representations with a registered facial representation, or the absence of a registered user based on not matching any of the detected facial representations with the registered facial representation, wherein the registered facial representation is associated with the registered user;
determining, by one or more processors, the presence of one or more unregistered users based on not matching any of the detected facial representations with the registered facial representation, or the absence of one or more unregistered users based on matching all of the detected facial representations with the registered facial representation;
presenting, responsive to determining the presence of the registered user and the absence of the one or more unregistered users, by one or more processors, data in a first, unrestricted manner; and
presenting, responsive to determining the presence of the one or more unregistered users, by one or more processors, data in a second, restricted manner.

2. The method of claim 1, further comprising:
storing information identifying which data is marked as private.

3. The method of claim 1, further comprising:
presenting, responsive to determining the absence of a registered user and the presence of one or more unregistered users, by one or more processors, data in a third, restricted manner.

4. The method of claim 1, further comprising:
transitioning automatically, responsive to determining the presence or absence of one or more registered users and the presence or absence of one or more unregistered users, from presenting data in a first, unrestricted manner to presenting data in a second, restricted manner, or from presenting data in a second, restricted manner to presenting data in a first, unrestricted manner.

5. The method of claim 3, further comprising:
transitioning automatically, responsive to determining the presence or absence of one or more registered users and the presence or absence of one or more unregistered users, from presenting data in a first, unrestricted manner to presenting data in a second or third restricted manner, or from presenting data in a second or third restricted manner to presenting data in a first, unrestricted manner.

6. The method of claim 1, wherein presenting data in a second, restricted manner comprises employing modifiable access restrictions.

7. The method of claim 3, wherein presenting data in a third, restricted manner comprises employing unmodifiable access restrictions.

8. The method of claim 6, wherein modifiable access restrictions hide data that is marked as private.

9. The method of claim 7, wherein unmodifiable access restrictions hide data that is marked as private.

10. A computer program product comprising:
one or more computer readable storage media and program instructions stored on the one or more computer readable storage media, the program instructions comprising:
program instructions to detect repeatedly facial representations visible within a field of view of one or more input devices;
program instructions to determine the presence of a registered user based on matching at least one of the detected facial representations with a registered facial representation, or the absence of a registered user based on not matching any of the detected facial representations with the registered facial representation, wherein the registered facial representation is associated with the registered user;
program instructions to determine the presence of one or more unregistered users based on not matching any of the detected facial representations with the registered facial representation, or the absence of one or more unregistered users based on matching all of the detected facial representations with the registered facial representation;
program instructions to present, responsive to determining the presence of the registered user and the absence of the one or more unregistered users, data in a first, unrestricted manner; and
program instructions to present, responsive to determining the presence of the one or more unregistered users, data in a second, restricted manner.

11. The computer program product of claim 10, further comprising:
program instructions to store information identifying which data is marked as private.

12. The computer program product of claim 10, further comprising:
program instructions to present, responsive to determining the absence of a registered user and the presence of one or more unregistered users, data in a third, restricted manner.

13. The computer program product of claim 10, further comprising:
program instructions to transition automatically, responsive to determining the presence or absence of one or more registered users and the presence or absence of one or more unregistered users, from presenting data in a first, unrestricted manner to presenting data in a second, restricted manner, or from presenting data in a second, restricted manner to presenting data in a first, unrestricted manner.

14. The computer program product of claim 12, further comprising:
program instructions to transition automatically, responsive to determining the presence or absence of one or more registered users and the presence or absence of one or more unregistered users, from presenting data in a first, unrestricted manner to presenting data in a second or third restricted manner, or from presenting data in a second or third restricted manner to presenting data in a first, unrestricted manner.

15. The computer program product of claim 10, wherein presenting data in a restricted manner comprises hiding data marked as private.

16. An adaptive data restriction system comprising:
one or more user interfaces;
one or more input devices;
one or more processors;
one or more computer readable storage media; and
program instructions stored on the one or more computer readable storage media for execution by at least one of the one or more processors, the program instructions comprising:
program instructions to detect repeatedly facial representations visible within a field of view of one or more input devices;
program instructions to determine the presence of a registered user based on matching at least one of the detected facial representations with a registered facial representation, or the absence of a registered user based on not matching any of the detected facial representations with the registered facial representation, wherein the registered facial representation is associated with the registered user;
program instructions to determine the presence of one or more unregistered users based on not matching any of the detected facial representations with the registered facial representation, or the absence of one or more unregistered users based on matching all of the detected facial representations with the registered facial representation;
program instructions to present, responsive to determining the presence of the registered user and the absence of the one or more unregistered users, data in a first, unrestricted manner; and
program instructions to present, responsive to determining the presence of the one or more unregistered users, data in a second, restricted manner.

17. The adaptive data restriction system of claim 16, further comprising:
program instructions to store information identifying which data is marked as private.

18. The adaptive data restriction system of claim 16, further comprising:
program instructions to present, responsive to determining the absence of a registered user and the presence of one or more unregistered users, data in a third, restricted manner.

19. The adaptive data restriction system of claim 16, further comprising:
program instructions to transition automatically, responsive to determining the presence or absence of one or more registered users and the presence or absence of one or more unregistered users, from presenting data in a first, unrestricted manner to presenting data in a second, restricted manner, or from presenting data in a second, restricted manner to presenting data in a first, unrestricted manner.

20. The adaptive data restriction system of claim 18, further comprising:
program instructions to transition automatically, responsive to determining the presence or absence of one or more registered users and the presence or absence of one or more unregistered users, from presenting data in a first, unrestricted manner to presenting data in a second or third restricted manner, or from presenting data in a second or third restricted manner to presenting data in a first, unrestricted manner.
